(19) United States
(12) Patent Application Publication
(10) Pub. No.: US 2019/0118491 A1
(43) Pub. Date: Apr. 25, 2019

(54) STONE-PLASTIC COMPOSITE REAL WOOD VENEER FLOOR AND METHOD

(71) Applicant: Log Floors Inc., La Puente, CA (US)

(72) Inventors: Qiang Xie, Beibao Town (CN); Hoa Hong Khang, La Puente, CA (US)

(21) Appl. No.: 15/791,417

(22) Filed: Oct. 24, 2017

(51) Int. Cl. B29C 65/00; B32B 21/08; B32B 25/02; B32B 37/12; B32B 7/12; B29C 45/00; B29B 7/00; B29C 65/48; E04F 15/04

(52) U.S. Cl. CPC B29C 66/7487; B32B 21/08; B32B 25/02; B32B 37/12; B29L 2031/732; B29C 45/0001; B29B 7/002; B29C 65/48; E04F 15/041; B32B 7/12

(57) ABSTRACT

The present application discloses a stone-plastic composite real wood veneer floor. The stone-plastic composite real wood veneer floor comprises a stone-plastic composite and a real wood veneer. The real wood veneer is adhered to the stone-plastic composite, wherein a composition of the real wood veneer is less than 12% water. The present application further discloses a method for manufacturing the abovementioned stone-plastic composite real wood veneer floor. The method comprises mixing a stone material and a plastic material to form a mixture; injection molding the mixture to form the stone-plastic composite; vacuum drying the real wood veneer to make the composition of the real wood veneer to be less than 12% water; and adhering the stone-plastic composite with the real wood veneer.

### TECHNICAL FIELD OF THE INVENTION

The present application generally relates to floors, and more particularly, to a stone-plastic composite real wood veneer floor and a method for manufacturing thereof.

### BACKGROUND OF THE INVENTION

A stone-plastic composite (SPC) real wood veneer floor is generally manufactured by compiling, a SPC and a real wood veneer via procedures of adhering, forming, coating and packaging etc.

However, a SPC and a real wood veneer may expand and contract significantly inconsistent when the thickness of the real wood veneer is over a specific value. Specifically, the shrinkage coefficients are very different since the structures between the SPC and the real wood veneer are inconsistent. This problem is even more serious especially in dry areas or the environment where humidity changes significantly.

Therefore, a need remains for an improved quality of a SPC real wood veneer floor and a method for manufacturing thereof.

### SUMMARY OF THE INVENTION

The present application discloses an improved quality of stone-plastic composite (SPC) real wood veneer floor and a method for manufacturing thereof.

The present application discloses a stone-plastic composite real wood veneer floor. The stone-plastic composite real wood veneer floor comprises a stone-plastic composite and a real wood veneer. The real wood veneer is adhered to the stone-plastic composite, wherein a composition of the real wood veneer is less than 12% water.

In various exemplary embodiments, the stone-plastic composite is adhered to the real wood veneer via a non-aldehyde adhesive layer.

The present application further discloses a method for manufacturing the abovementioned stone-plastic composite real wood veneer floor. The method comprises mixing a stone material and a plastic material to form a mixture; injection molding the mixture to form the stone-plastic composite; vacuum drying the real wood veneer to make the composition of the real wood veneer to be less than 12% water; and adhering the stone-plastic composite with the real wood veneer.

In various exemplary embodiments, wherein the step of mixing the stone material and the plastic material to form the mixture comprises: mixing the stone material and the plastic material at a high temperature; and mixing the stone material and the plastic material at a low temperature. The step of mixing the stone material and the plastic material at the high temperature is performed at 125° C. The step of mixing the stone material and the plastic material at the low temperature is performed at 55° C.

In various exemplary embodiments, wherein after mixing the stone material and the plastic material to form the mixture, the method further comprises leaving the mixture untouched for at least 240 hours. The step of leaving the mixture untouched for at least 240 hours is performed in a constant temperature and humidity environment. After injection molding the mixture to form the stone-plastic composite, the method further comprises making at least one slot in the mixture.

In various exemplary embodiments, wherein the step of adhering the stone-plastic composite with the real wood veneer comprises adhering the stone-plastic composite and the real wood veneer via a non-aldehyde adhesive layer.

In various exemplary embodiments, wherein before adhering the stone-plastic composite with the real wood veneer, the method further comprises sanding the stone-plastic composite.

In various exemplary embodiments, wherein before adhering the stone-plastic composite with the real wood veneer, the method further comprises removing excess surface charges from the stone-plastic composite.

In various exemplary embodiments, wherein before adhering the stone-plastic composite with the real wood veneer, the method further comprises removing dust from the stone-plastic composite.

In various exemplary embodiments, wherein after adhering the stone-plastic composite with the real wood veneer, the method further comprises leaving the stone-plastic composite and the real wood veneer untouched for at least 72 hours. The step of leaving the stone-plastic composite and the real wood veneer untouched for at least 72 hours is performed in a constant temperature and humidity environment. After leaving the stone-plastic composite and the real wood veneer untouched for at least 72 hours, the method further comprises adhering a noise reducing layer to the stone-plastic composite.

In various exemplary embodiments, wherein after adhering the stone-plastic composite with the real wood veneer, the method further comprises leaving the stone-plastic composite and the real wood veneer untouched for at least 72 hours. The step of leaving the stone-plastic composite and the real wood veneer untouched for at least 72 hours is performed in a constant temperature and humidity environment. After leaving the stone-plastic composite and the real wood veneer untouched for at least 72 hours, the method further comprises coating a coloring layer onto the real wood veneer; coating an elastic layer onto the coloring layer; coating a wear-resisting layer onto the elastic layer; and coating a waterproof layer onto the wear-resisting layer.

Based on the above, the stone-plastic composite real wood veneer floor of the present application is suitable of being utilized in an environment with various temperature without significant shrinkage differences between the stone-plastic composite and the real wood veneer. Specifically, since the composition of the real wood veneer is less than 12% water, the real wood veneer shrinkage affected by high moisture content can be prevented.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIGS. 1A-1B are flow charts of a method for manufacturing a stone-plastic composite real wood veneer floor.

FIGS. 2A-2G are cross-sectional views of the stone-plastic composite real wood veneer floor showing the manufacturing process thereof according to the first embodiment of the present application.

FIG. 3 is a view showing the combination of multiple stone-plastic composite real wood veneer floor according to the first embodiment of the present application.

FIG. 4 is a cross-sectional views of the stone-plastic composite real wood veneer floor showing the manufacturing process thereof according to the second embodiment of the present application.

FIG. 5 is a view showing the combination of multiple stone-plastic composite real wood veneer floor according to the second embodiment of the present application.

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

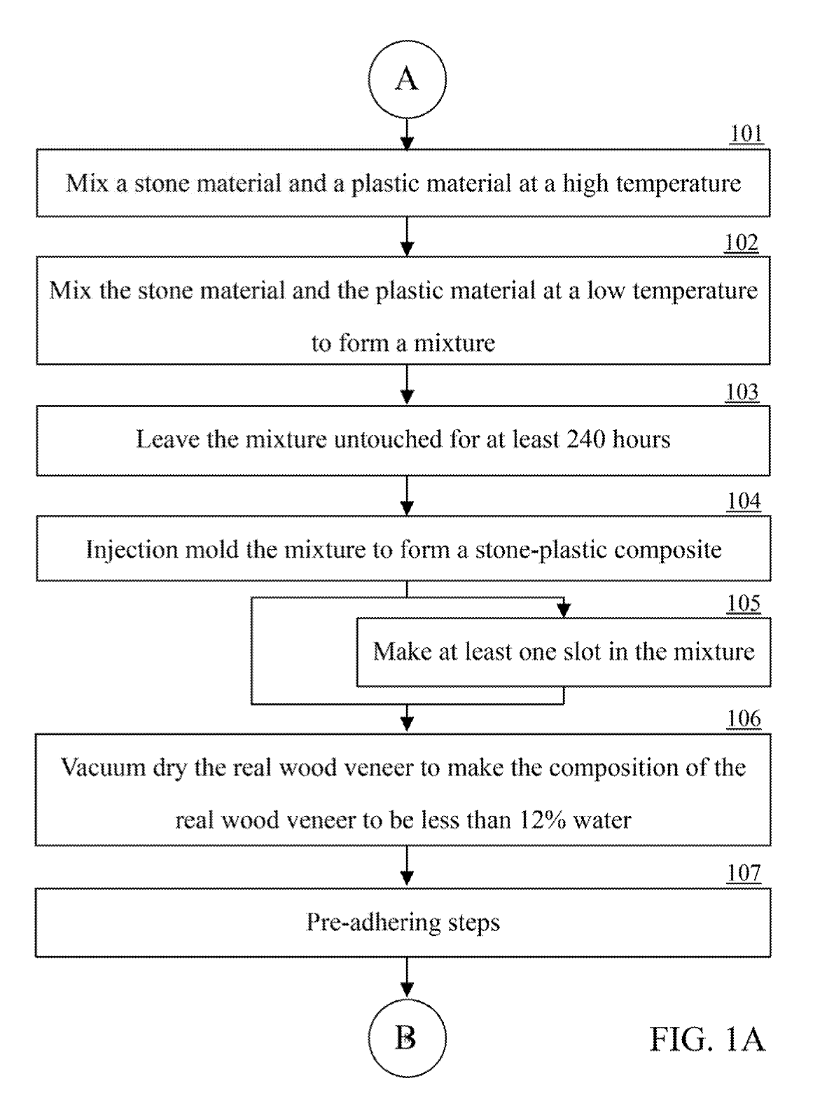

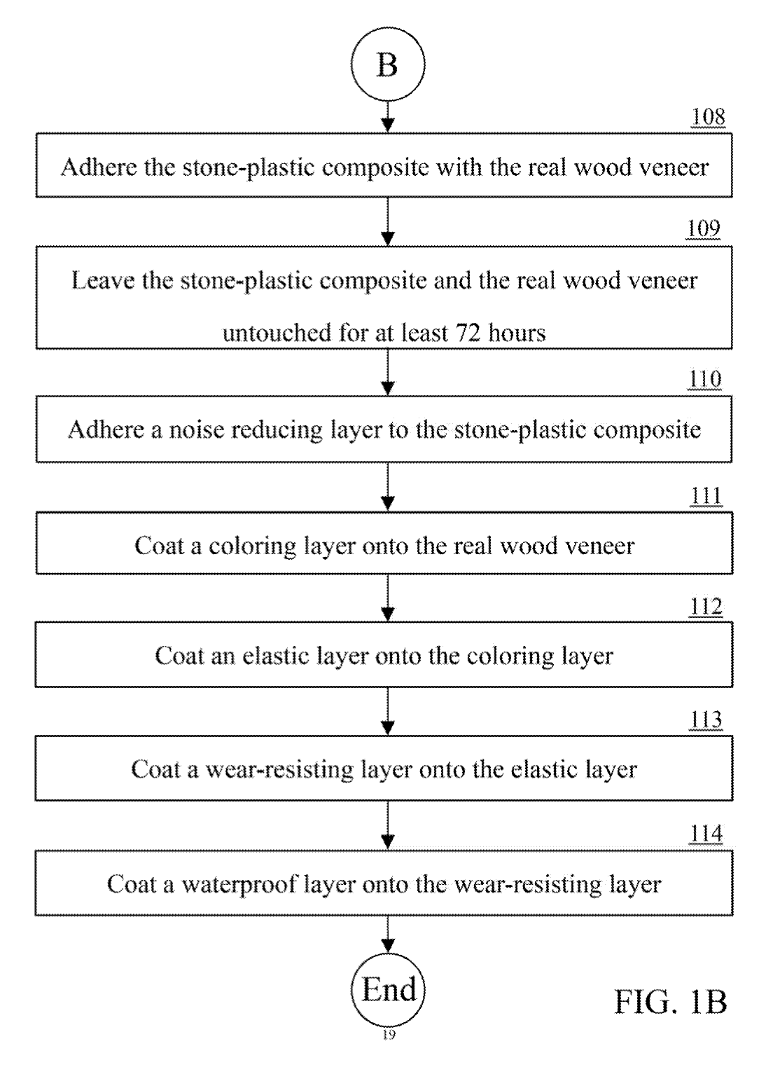

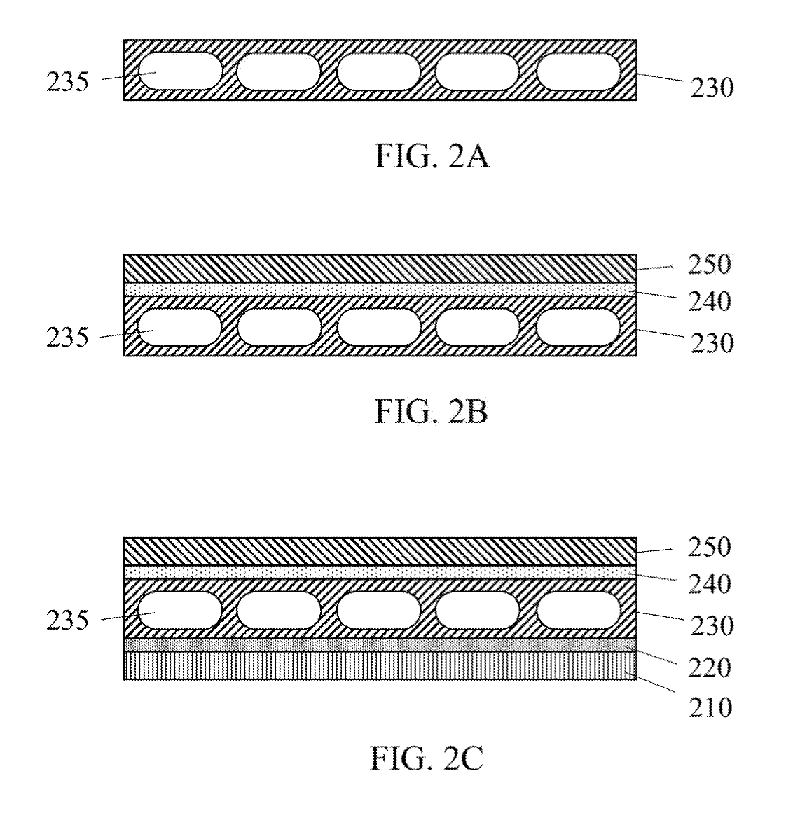

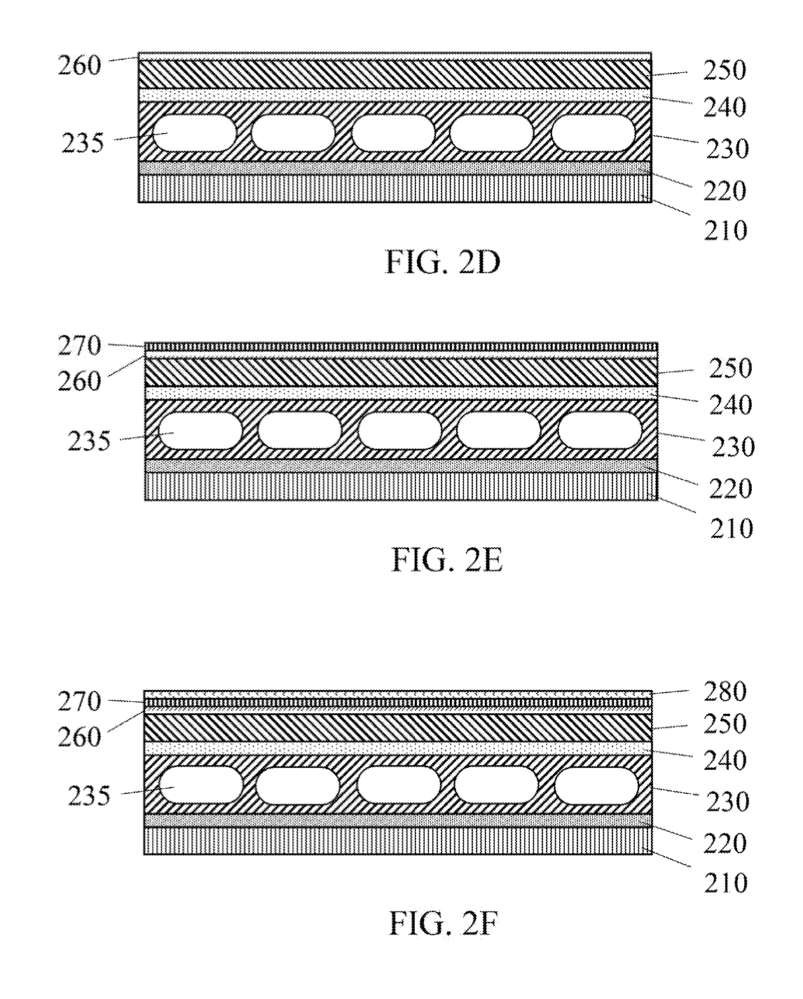

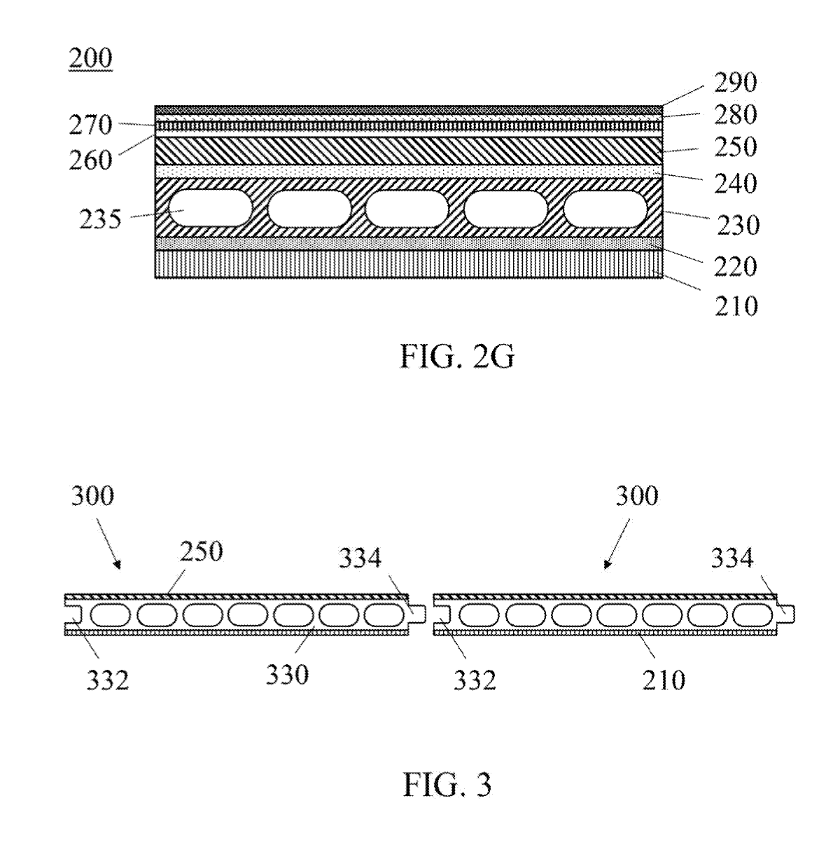

FIGS. 1A-1B are flow charts of a method for manufacturing a stone-plastic composite (SPC) real wood veneer floor according to the first embodiment of the present application. FIGS. 2A-2G are cross-sectional views of the SPC real wood veneer floor showing the manufacturing process thereof according to the first embodiment of the present application.

Referring to FIG. 1, the first step of manufacturing SPC real wood veneer floor is mixing a stone material and a plastic material to form a mixture. The manufacturer may set proportion of the stone material to the plastic material according to different demands such as hardness or climate factors.

Specifically, the mixing procedure comprises mixing the stone material and the plastic material at a high temperature and then a low temperature to form a mixture as shown in step 101 and step 102. The high temperature mixture is performed via a high speed mixer at 125° C. for excluding moisture in the stone material and the plastic material. The low temperature mixture is performed at 55° C. for lowering down the temperature to prevent agglomeration and discoloration.

As shown in step 103, then leave the mixture untouched in a constant temperature and humidity environment for at least 240 hours to stabilize the physical properties. As shown in step 104, a double screw extruder then heats up and injection molds the mixture to form a SPC 230 (referring to FIG. 2A). Specifically, the SPC 230 (referring to FIG. 2A) is formed after a basic material, which is injection molded by the double screw extruder, is rolled by a four-roller calender. The four-roller calender is capable of fix the thickness and weight of every SPC 230 (referring to FIG. 2A) as the same.

Referring to FIGS. 1A and 2A, making at least one slot 235 on the SPC 230 after injection molding for decreasing the thermal expansion and contraction caused by the temperature. In detail, the slots 235 of the present application are oval and extend from one side to the opposite side of the SPC 230. By the above structure, the slots 235 may further provide more structural integrity when overloading subjects. However, the slots 235 can be any kind of shapes and depth, the present application is not limited thereto as long as the slots 235 can bring the same functionalities as mentioned above.

Referring to FIG. 2B and step 106 in FIG. 1A, the real wood veneer 250 is vacuum dried for making the composition of the real wood veneer 250 to be less than 12% water. By doing so, the thermal contraction of the real wood veneer 250 caused by high real wood veneer moisture and dry climate can be reduced.

It should be noted that the sequence of the steps 101-105 and step 106 can be switched. In other words, the real wood veneer 250 can be vacuum dried first and then manufacturing the SPC 230, and vice versa.

As shown in step 107 in FIG. 1A, the pre-adhering step 107 comprises sanding the stone-plastic composite for adhering with a real wood veneer 250; removing excess surface charges and dust from the SPC 230 to prevent failure adherence with the real wood veneer 250 due to foreign material.

Referring to FIG. 1B and FIG. 2B, adhering the SPC 230 with the real wood veneer 250 after pre-adhering steps as shown in step 108. Specifically, the adhesive layer 240 is a non-adhesive layer. The non-adhesive layer 240 is not only environmental-friendly, but also can increase its stickiness. Therefore, the intercellular stress in the real wood veneer 250 produced by moisture changes within the wood cells can be offset due to higher stickiness, of the adhesive layer 240.

The thickness of the adhesive layer 240 is between 0.1 mm to 0.3 mm, or equal to 0.1 mm or 0.3 mm. The thickness of the real wood veneer 250 is between 0.3 mm to 4 mm, or equal to 0.3 mm or 4 mm.

As shown in step 109, after adhering the SPC 230 and the real wood veneer 250, leaving the SPC 230 and the real wood veneer 250 untouched for at least 72 hours in a constant temperature and humidity environment to prevent the adhesive layer 240 from peeling off. Specifically, the SPC 230 and the real wood veneer 250 should be placed in a flat tray or plate with the same size as the SPC 230 and the real wood veneer 250 to prevent deformation.

As shown in step 110 in FIG. 1B and FIG. 2C, after leaving the SPC 230 and the real wood veneer 250 untouched for at least 72 hours, then adhering a noise reducing layer 210 to the SPC 230 via an adhesive layer 220. Specifically, the thickness of the noise reducing layer 210 is between 1 mm to 4 mm, or equal to 1 mm or 4 mm.

Before coating any layer on the real wood veneer 250, the method may further comprise carve the real wood veneer 250 to make the natural texture of wood be more clear and pretty. In addition, the surface of the real wood veneer 250 may also be painted in a customer-oriented way such as antique, modern or fashion way.

As shown in step 111 in FIG. 1B and FIG. 2D, a coloring layer 260 is coated onto the real wood veneer 250. Specifically, the coloring layer 260 is an environmental-friendly and water-based layer. Therefore, the color of the real wood veneer 250 can be more abundant and beautiful.

As shown in step 112 in FIG. 1B and FIG. 2E, an elastic layer 270 is coated onto the coloring layer 260 to increase the comfortability when stepping on.

As shown in step 113 in FIG. 1B and FIG. 2F, a wear-resisting layer 280 is coated onto the elastic layer 270 for increasing the abrasion resistance of the real wood veneer 250.

As shown in step 114 in FIG. 1B and FIG. 2G, a waterproof layer 290 is coated onto the wear-resisting layer 280.

In addition, before coating the waterproof layer 290, the method may further comprise coating a matte base layer for thickening the overall SPC real wood veneer floor 200 to enhance the waterproof ability; or coating a matte topcoat layer for smoothening the surface of the real wood veneer 250.

The thickness of each of the layer on the real wood veneer 250 is between 0.05 mm to 0.15 mm, or equal to 0.05 mm or 0.15 mm. Therefore, according to the thickness value mentioned above, the overall thickness of the real wood veneer 250, the coloring layer 260, the elastic layer 270, the wear-resisting layer 280 and the waterproof layer 290 is between 0.3 mm to 6 mm, or equal to 0.3 mm or 6 mm. The overall thickness of the SPC real wood veneer floor 200 is between 4 mm to 18 mm, or equal to 4 mm or 18 mm.

In addition, the length of the SPC real wood veneer floor is between 300 mm to 2200 mm, or equal to 300 mm or 2200 mm. The width of the SPC real wood veneer floor is between 70 mm to 220 mm, or equal to 70 mm or 220 mm. The density of the SPC real wood veneer floor is between 1.9 T/m³ to 2 T/m³ or equal to 1.9 or 2 T/m³. However, the present application is not limited, the scale and the size of the SPC real wood veneer floor can be modified according to different needs.

FIG. 3 is a view showing the combination of multiple stone-plastic composite real wood veneer floor according to the first embodiment of the present application.

Referring to FIG. 3, a SPC real wood veneer floor 300 comprises a groove 332 and a ridge 334. The groove 332 of the SPC real wood veneer floor 300 is capable of coupling to the ridge 334 of another SPC real wood veneer floor 300. By doing so, the SPC real wood veneer floor 300 can be easily assembled and maintained.

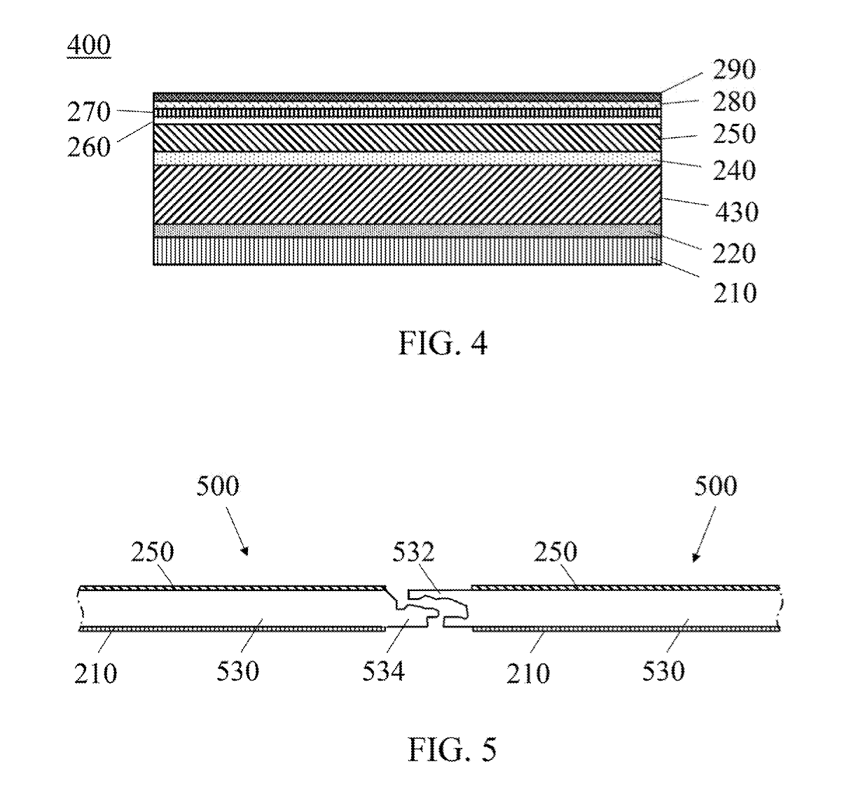

FIG. 4 is a cross-sectional views of the stone-plastic composite real wood veneer floor showing the manufacturing process thereof according to the second embodiment of the present application. FIG. 5 is a view showing the combination of multiple stone-plastic composite real wood veneer floor according to the second embodiment of the present application.

Referring to FIG. 1A and FIG. 4, the present application further comprises another embodiment of SPC real wood veneer floor 400. The difference between SPC real wood veneer floor 400 and SPC real wood veneer floor 200 is that a SPC composite 430 is solid but the SPC composite 230 (referring to FIG. 2G) comprises slots 235.

For the second embodiment of the present application, as shown in FIG. 5, a SPC real wood veneer floor 500 comprises a clicking system including a ridge 534 and a groove 532. Specifically, although FIG. 5 does not show both the ridge 534 and the groove 532 in the same SPC real wood veneer floor 500, one SPC real wood veneer floor 500 may comprise the ridge 534 at one end and the groove 532 at another end. The groove 532 of the SPC real wood veneer floor 500 is capable of coupling to the ridge 534 of another SPC real wood veneer floor 500.

In detail, the clicking system is a unilin click system for SPC real wood veneer floor 500 with solid SPC composite 530. However, the present application is not limited thereto, the clicking system may also be a single clicking system, an arc clicking system or a double clicking system.

Base on the above structure, under the testing environment of 80° C. for 6 hours, the shrinkage of the SPC real wood veneer floor is less than or equal to 1‰ after tempering treatment, and is less than or equal to 2.5‰ after tempering treatment.

In conclusion, the SPC real wood veneer floor of the present application is suitable of being utilized in an environment with various temperature without significant shrinkage differences between the stone-plastic composite and the real wood veneer. Specifically, since the composition of the real wood veneer is less than 12% water, the real wood veneer shrinkage affected by high moisture content can be prevented. Therefore, the SPC real wood veneer floor is suitable for utilizing in any indoor spaces with the temperature from −20° C. to 60° C.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

What is claimed is:

1. A stone-plastic composite real wood veneer floor, comprising:
a stone-plastic composite; and
a real wood veneer adhered to the stone-plastic composite, wherein a composition of the real wood veneer is less than 12% water.

2. The stone-plastic composite real wood veneer floor as claimed in claim 1, wherein the stone-plastic composite is adhered to the real wood veneer via a non-aldehyde adhesive layer.

3. A method for manufacturing stone-plastic composite real wood veneer floor of claim 1, comprising:
mixing a stone material and a plastic material to form a mixture;
injection molding the mixture to form the stone-plastic composite;
vacuum drying the real wood veneer to make the composition of the real wood veneer to be less than 12% water; and
adhering the stone-plastic composite with the real wood veneer.

4. The method for manufacturing stone-plastic composite real wood veneer floor as claimed in claim 3, wherein the step of mixing the stone material and the plastic material to form the mixture comprises:
mixing the stone material and the plastic material at a high temperature; and
mixing the stone material and the plastic material at a low temperature.

5. The method for manufacturing stone-plastic composite real wood veneer floor as claimed in claim 4, wherein the step of mixing the stone material and the plastic material at the high temperature is performed at 125° C.

6. The method for manufacturing stone-plastic composite real wood veneer floor as claimed in claim 4, wherein the step of mixing the stone material and the plastic material at the low temperature is performed at 55° C.

7. The method for manufacturing stone-plastic composite real wood veneer floor as claimed in claim 3, wherein after mixing the stone material and the plastic material to form the mixture, the method further comprises leaving the mixture untouched for at least 240 hours.

8. The method for manufacturing stone-plastic composite real wood veneer floor as claimed in claim 7, wherein the step of leaving the mixture untouched for at least 240 hours is performed in a constant temperature and humidity environment.

9. The method for manufacturing stone-plastic composite real wood veneer floor as claimed in claim 3, wherein after injection molding the mixture to form the stone-plastic composite, the method further comprises making at least one slot in the mixture.

10. The method for manufacturing stone-plastic composite real wood veneer floor as claimed in claim 3, wherein the step of adhering the stone-plastic composite with the real wood veneer comprises adhering the stone-plastic composite and the real wood veneer via a non-aldehyde adhesive layer.

11. The method for manufacturing stone-plastic composite real wood veneer floor as claimed in claim 3, wherein before adhering the stone-plastic composite with the real wood veneer, the method further comprises sanding the stone-plastic composite.

12. The method for manufacturing stone-plastic composite real wood veneer floor as claimed in claim 3, wherein before adhering the stone-plastic composite with the real wood veneer, the method further comprises removing excess surface charges from the stone-plastic composite.

13. The method for manufacturing stone-plastic composite real wood veneer floor as claimed in claim 3, wherein before adhering the stone-plastic composite with the real wood veneer, the method further comprises removing dust from the stone-plastic composite.

14. The method for manufacturing stone-plastic composite real wood veneer floor as claimed in claim 3, wherein after adhering the stone-plastic composite with the real wood veneer, the method further comprises leaving the stone-plastic composite and the real wood veneer untouched for at least 72 hours.

15. The method for manufacturing stone-plastic composite real wood veneer floor as claimed in claim 14, wherein the step of leaving the stone-plastic composite and the real wood veneer untouched for at least 72 hours is performed in a constant temperature and humidity environment.

16. The method for manufacturing stone-plastic composite real wood veneer floor as claimed in claim 14, wherein after leaving the stone-plastic composite and the real wood veneer untouched for at least 72 hours, the method further comprises adhering a noise reducing layer to the stone-plastic composite.

17. The method for manufacturing stone-plastic composite real wood veneer floor as claimed in claim 14, wherein after leaving the stone-plastic composite and the real wood veneer untouched for at least 72 hours, the method further comprises coating a coloring layer onto the real wood veneer.

18. The method for manufacturing stone-plastic composite real wood veneer floor as claimed in claim 17, wherein after coating the coloring layer onto the real wood veneer, the method further comprises coating an elastic layer onto the coloring layer.

19. The method for manufacturing stone-plastic composite real wood veneer floor as claimed in claim 18, wherein after coating the elastic layer onto the coloring layer, the method further comprises coating a wear-resisting layer onto the elastic layer.

20. The method for manufacturing stone-plastic composite real wood veneer floor as claimed in claim 19, wherein after coating the wear-resisting layer onto the elastic layer, the method further comprises coating a waterproof layer onto the wear-resisting layer.
